(19) United States
(12) Patent Application Publication
(10) Pub. No.: US 2019/0067959 A1
(43) Pub. Date: Feb. 28, 2019

(54) BATTERY PACK BALANCING SYSTEM

(71) Applicant: GE Aviation Systems Limited, Gloucestershire (GB)

(72) Inventor: Stephen Charles Burden, Tewkesbury (GB)

(21) Appl. No.: 16/041,962

(22) Filed: Jul. 23, 2018

(30) Foreign Application Priority Data
Aug. 25, 2017 (GB) 1713678.9

(51) Int. Cl. H02J 7/00; H02J 7/04; H01M 10/44

(52) U.S. Cl. CPC H02J 7/0019; H01M 10/441; H02J 7/045

(57) ABSTRACT

A method and apparatus for operating a battery pack balancing system includes a set of power units including a set of battery cells, the set of power units having a respective set of terminals selectably connected with a circuit, a set of sensors adapted to sense the amount of power available at the respective terminals of the set of power units, and a controller module adapted to receive the sensed power available at the respective terminals of the set of power units from the set of sensors and identify the power unit having the largest amount of power available at the terminals.

### BACKGROUND OF THE INVENTION

Batteries are comprised of multiple cells that can be, for example, connected in series to achieve a desired battery voltage. Some batteries or battery cells can include a rechargeable composition such that the batteries or battery cells can be repeatedly discharged and recharged. The batteries or battery cells can further include differing electrical characteristics, including, but not limited to self-discharge, capacity, impedance, or the like. Thus, over a period of usage, or even non-usage, an individual state-of-charge (i.e. amount of electrical power stored) of batteries or battery cells may not be identical.

### SUMMARY OF THE INVENTION

In one aspect, the disclosure relates to a battery pack balancing system including a set of battery cells having a respective set of terminals selectably connected with a power rail, a set of power converters connected with the power rail and the set of terminals, a set of sensors adapted to sense the amount of power available at the respective terminals of the set of battery cells, and a controller module adapted to receive the sensed power available at the respective terminals of the set of battery cells from the set of sensors, identify the battery cell having a larger amount of power available at the terminals, relative to at least one other battery cell, selectably connect the battery cell having the larger amount of power available at the terminals with the power rail, and controllably operate at least a subset of the power converters to recharge at least a corresponding subset of the battery cells having a smaller amount of power, relative to the battery cell having the larger amount, by way of discharging the battery cell having the larger amount of power available at the terminals.

In another aspect, the disclosure relates to a method of balancing a battery pack, including sensing, by a set of power sensors, a respective amount of power available from a set of power units, comparing, by a controller module, the sensed amount of power available from the set of power units, identifying, by the controller module, the power unit having the largest amount of power available based on the comparison, and enabling, by the controller module, the power unit having the largest amount of power available to recharge at least another subset of the power units.

In yet another aspect, the disclosure relates to a battery pack balancing system including a set of power units including a set of battery cells and at least one external power source, the set of power units having a respective set of terminals selectably connected with a circuit, a set of sensors adapted to sense the amount of power available at the respective terminals of the set of power units, and a controller module adapted to receive the sensed power available at the respective terminals of the set of power units from the set of sensors, identify the power unit having the largest amount of power available at the terminals, selectably supply power from the power unit having the largest amount of power available at the terminals to the circuit, and controllably recharge at least a corresponding subset of the battery cells by way of the circuit.

### BRIEF DESCRIPTION OF THE DRAWINGS

FIG. 1 illustrates a top-down schematic view of an aircraft power system having a battery pack balancing system, in accordance with various aspects described herein.

FIG. 2 illustrates a schematic view of the battery pack balancing system of FIG. 1, in accordance with various aspects described herein.

FIG. 3 is a diagram of demonstrating a method of balancing a battery pack in accordance with various aspects described herein.

### DETAILED DESCRIPTION

The described aspects of the present disclosure are directed to a method and system associated with a balancing a set of batteries, battery cells, or a battery pack. Aspects of the disclosure can be included in any number of environments where a set of batteries, battery cells, or a battery pack can be used or utilized. Additionally, aspects of the disclosure are not limited to environments where the set of batteries, battery cells, or battery pack are actively powering an electrical load with electrical energy. For instance, aspects of the present disclosure can be utilized in a set of batteries being stored without energizing or actively discharging electrical power. One example environment where such a method and apparatus can be used includes, but is not limited to, a power distribution system for an aircraft.

While “a set of” various elements will be described, it will be understood that “a set” can include any number of the respective elements, including only one element. Also as used herein, while sensors can be described as “sensing” or “measuring” a respective value, sensing or measuring can include determining a value indicative of or related to the respective value, rather than directly sensing or measuring the value itself. The sensed or measured values can further be provided to additional components. For instance, the value can be provided to a controller module or processor, and the controller module or processor can perform processing on the value to determine a representative value or an electrical characteristic representative of said value.

As used herein, a “battery” or “battery bank” can include any number of storage components adapted to store or discharge electrical power. The battery can be of lithium-ion composition, and any number of battery cells can be concatenated in series to contribute to an overall battery or battery stack operating voltage. While a typical battery accomplishes power storage via a chemical reaction storing or producing electrical power at a set of respective terminals, non-limiting examples of batteries can be included having non-chemistry based power storage. Additionally, while terms such as “voltage”, “current”, and “power” can be used herein, it will be evident to one skilled in the art that these terms can be interchangeable when describing aspects of the electrical circuit, circuit operations, power, power storage, and the like.

Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. In non-limiting examples, connections or disconnections can be selectively configured to provide, enable, disable, or the like, an electrical connection between respective elements. Non-limiting example power distribution bus connections or disconnections can be enabled or operated by way of switching, bus tie logic, or any other connectors configured to enable or disable the energizing or recharging of electrical components downstream of the connector.

As used herein, a “system” or a “controller module” can include at least one processor and memory. Non-limiting examples of the memory can include Random Access Memory (RAM), Read-Only Memory (ROM), flash memory, or one or more different types of portable electronic memory, such as discs, DVDs, CD-ROMs, etc., or any suitable combination of these types of memory. The processor can be configured to run any suitable programs or executable instructions designed to carry out various methods, functionality, processing tasks, calculations, or the like, to enable or achieve the technical operations or operations described herein. The program can include a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, algorithms, etc., that have the technical effect of performing particular tasks or implement particular abstract data types.

As used herein, a controllable switching element, or a “switch” is an electrical device that can be controllable to toggle between a first mode of operation, wherein the switch is “closed” intending to transmit current from a switch input to a switch output, and a second mode of operation, wherein the switch is “open” intending to prevent current from transmitting between the switch input and switch output. In non-limiting examples, connections or disconnections, such as connections enabled or disabled by the controllable switching element, can be selectively configured to provide, enable, disable, or the like, an electrical connection between respective elements.

Also as used herein, a power converter is an electrical device enabled or controllably operable to convert power having a first set of power characteristics (e.g. a first voltage or a first current, etc.) received at a power input to another, a different, or a second set of power characteristics (e.g. a second voltage or a second current, etc.) supplied to a power output. Non-limiting examples of power conversion enabled by the power converter can include step-up or step-down power conversion, DC to AC power conversion, AC to DC power conversion, AC to AC power conversion, DC to DC power conversions, the like, or a combination thereof.

The exemplary drawings are for purposes of illustration only and the dimensions, positions, order and relative sizes reflected in the drawings attached hereto can vary.

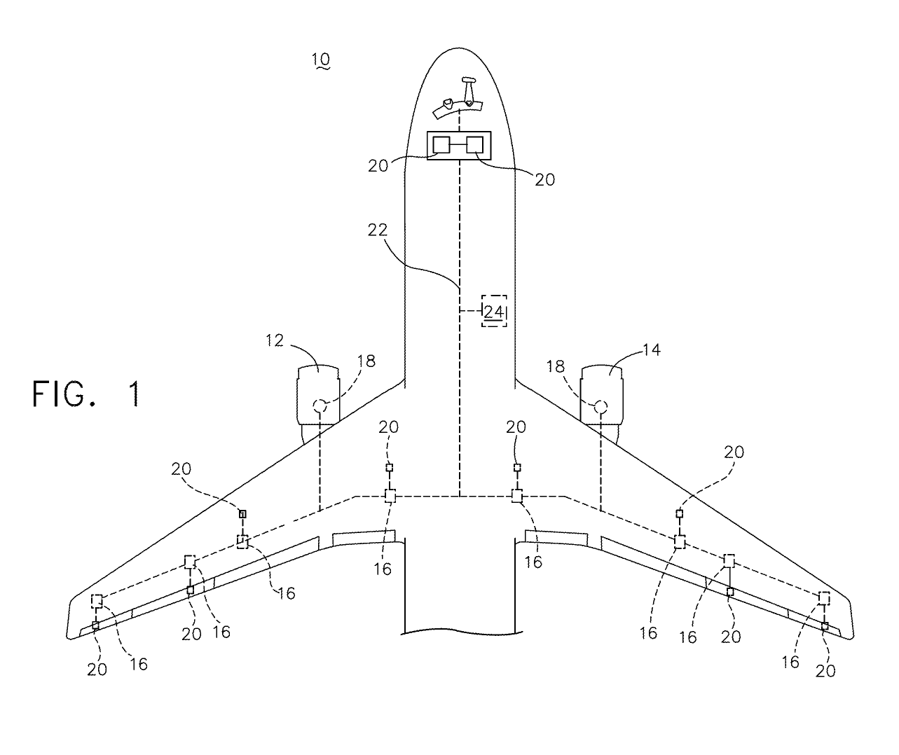

As illustrated in FIG. 1, an aircraft 10 is shown having at least one gas turbine engine, shown as a left engine system 12 and a right engine system 14. Alternatively, the power system can have fewer or additional engine systems. The left and right engine systems 12, 14 can be substantially identical, and can further include at least one power source, such as an electric machine or a generator 18. The aircraft 10 is shown further having a set of power-consuming components, or electrical loads 20, such as for instance, an actuator load, flight critical loads, and non-flight critical loads. The electrical loads 20 are electrically coupled with at least one of the generators 18 via a power distribution system including, for instance, power transmission lines 22 or bus bars, and power distribution nodes 16.

The aircraft 10 can further include a supplemental power source, illustrated schematically as a battery pack 24 connected with the transmission lines 22 or bus bars. Non-limiting examples of the battery pack 24 can include power conversion components adapted to convert power stored in or supplied by the battery pack 24 to power suitable for the transmission lines for distribution. While a single battery pack 24 is schematically illustrated, non-limiting aspects of the disclosure can be included wherein a set of battery packs 24, a bank of batteries, a set of battery cells, or the like, are included. In yet another non-limiting example of the disclosure, the battery pack 24 can include at least one rechargeable battery, that is, a battery adapted to be at least partially electrically discharged and recharged over a number of cycles.

It will be understood that the illustrated aspect of the disclosure of FIG. 1 is only one non-limiting example of a power distribution system, and many other possible aspects and configurations in addition to that shown are contemplated by the present disclosure. Furthermore, the number of, and placement of, the various components depicted in FIG. 1 are also non-limiting examples of aspects associated with the disclosure.

In the aircraft 10, the operating left and right engine systems 12, 14 provide mechanical energy which can be extracted, typically via a spool, to provide a driving force for the generator 18. The generator 18, in turn, generates power, such as AC or DC power, and provides the generated power to the transmission lines 22, which delivers the power to the power distribution nodes 16, positioned throughout the aircraft 10. The power distribution nodes 16 receive the AC or DC power via the transmission lines 22, and can provide switching, power conversion, or distribution management functions, as needed, in order to provide the desired electrical power to the electrical loads 20 for load operations. In further non-limiting aspects of the disclosure, additional power, supplemental power, redundant power, or the like, can be supplied to the transmission lines 22 via electrical power stored in the battery pack 24, as requested or desired for load operations.

Regardless of the operating environment of the battery pack, a subset of the batteries or battery cells of the battery pack 24 can have different or dissimilar power characteristics including, but not limited to self-discharge, capacity, impedance, or the like. Thus, over a period of usage, or even non-usage, an individual state-of-charge (i.e. amount of electrical power stored) of batteries or battery cells may not be identical. In some non-limiting instances, dissimilar or different state-of-charges in individual batteries or battery cells can compromise the overall battery pack 24 state-of-charge. Thus, in non-limiting instances, it can be desirable to “balance” the batteries, battery cells, or individual energy power storage units, such that the battery bank 24 includes a set of batteries, battery cells, or individual energy power storage units having similar, substantially equal, or minimal electrical characteristics, relative to the other batteries, cells, or units of the battery bank 24.

As used herein “balancing” the battery bank 24 can include, but is not limited to, distributing power from one or more batteries, battery cells, or another source of electrical power, such as an external power supply, to at least one other battery or battery cell. Balancing the battery bank 24 can be based on a set of desired electrical characteristics, including, but not limited to, obtaining a set of batteries or battery cells having equal or substantially equal voltages, currents, stored power, available power, satisfying a threshold thereof, or a combination thereof. As used herein, the term “satisfies” with respect to a threshold value means that a respective value is equal to or greater than the threshold value, or being within a threshold value range (e.g. within tolerance). It will be understood that such a determination may easily be altered to be satisfied by a positive/negative comparison or a true/false comparison. In one non-limiting aspect of the disclosure, satisfying a threshold of the aforementioned power characteristics can include falling within a threshold value range, such as between 3.9 volts direct current (DC) and 4.1 volts DC. Additional thresholds and threshold ranges can be included.

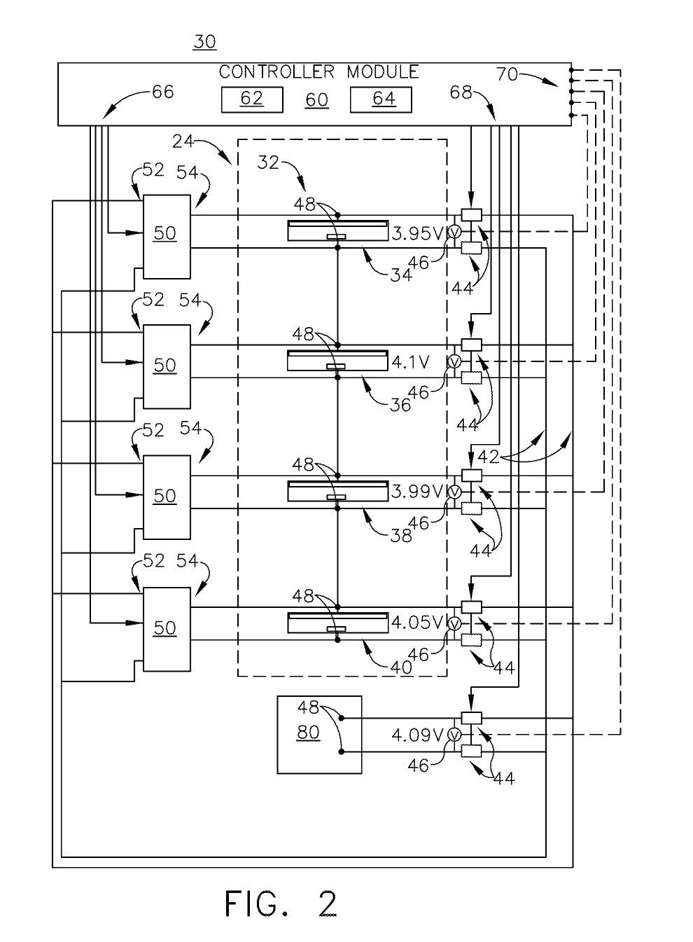

FIG. 2 illustrates a schematic circuit diagram of a battery pack balancing system 30 or circuit that can be utilized in the aircraft 10 of FIG. 1 or another environment having a battery pack 24. As shown, the battery pack balancing system 30 can include a battery pack 24 comprising a set of batteries 32. Each respective battery 32 of the set of batteries 32 can include at least one battery cell. As illustrated, the set of batteries 32 can include, respectively, a first battery cell 34, a second battery cell 36, a third battery cell 38, and a fourth battery cell 40. While only a single battery cell 34, 36, 38, 40 is illustrated for ease of understanding, the set of batteries 32, or the battery cells 34, 36, 38, 40 can include a set of respective cells 34, 36, 38, 40 arranged, configured, adapted, enable, or the like, to provide any desired power output, storage capacity, or power storage capabilities envisioned. Each of the set of batteries 32 or battery cells 34, 36, 38, 40 is shown having a respective set of battery terminals 48 for providing or receiving electrical power.

The set of batteries 32 or battery cells 34, 36, 38, 40 is selectably connectable with a common set of power rails 42, via a respective set of switchable elements 44. The switchable elements 44 can be adapted to selectably connect or disconnect the set of batteries 32 or battery cells 34, 36, 38, 40 in response a control signal. In this sense, the set of switchable elements 44 can effectively, operably, or controllably isolate respective terminals 48, battery cell 34, 36, 38, 40 outputs, or the like, from the set of power rails 42. Non-limiting examples of the switchable elements 44 can include double-pole switches, solid state switches, or the like. The battery pack balancing system 30 can also include a set of power converters 50 corresponding or associated with the set of batteries 32 or battery cells 34, 36, 38, 40. As shown, each of the set of power converters 50 can include a power input 52 connected with the common power rail 42 and a power output 54 connected with the respectively associated battery cell 34, 36, 38, 40, or battery terminals 48. Non-limiting aspects of the set of power converters 50 can be included wherein they are operably enabled to perform power conversion operations in response to a control signal.

The battery pack balancing system 30 can further include a set of sensors 46 arranged or adapted to sense or measure a power characteristic of the set of batteries 32 or battery cells 34, 36, 38, 40. For example, as illustrated, the set of sensors 46 can include voltage sensors adapted to sense or measure the voltage of the respective set of batteries 32 or battery cells 34, 36, 38, 40. While a set of voltage sensors are illustrated, the set of sensors can be configured, adapted, or the like to sense or measure a value or characteristic related to an amount of power available in or from the respective battery 32 or battery cell 34, 36, 38, 40. The set of sensors 46 can also be adapted or configured to provide the sensed or measured value or characteristic related to the amount of power available in or from the respective battery 32 or battery cell 34, 36, 38, 40 to another component.

The battery pack balancing system 30 can also include a controller module 60 having a processor 62 and memory 64. As shown, the controller module 60 can be connected with the set of sensors 46 and receive a set of inputs 70 for the sensed or measured value or characteristic related to the amount of power available in or from the respective batteries 32 or battery cells 34, 36, 38, 40. The controller module 60 can also be connected with the set of power converters 50 by a first set of control signal outputs 66. The first set of control signal outputs 66 can be operable to provide a control signal to enable or disable the power converting functionality of a set or subset of the power converters 50. The controller module 60 is also shown connected with the respective sets of switchable elements 44 at a second set of control signal outputs 68. The second set of control signal outputs 68 can be operable to provide a control signal to connect or disconnect a respective battery 32 or battery cell 34, 36, 38, 40 with the common power rail 42.

The battery pack balancing system 30 can further include an optional external power source 80, having a respective set of terminals 48, and having a set of switchable elements 44 adapted to selectably connect or disconnect the external power source 80 with the common power rail 42, in response a control signal. The amount of power available in or from the external power source 80 can further be sensed or measured by a sensor 46, as described herein. Non-limiting examples of the battery pack balancing system 30 can be included wherein the sensor 46 and set of switchable elements 44 associated with the external power source 80 can be connected with the controller module 60 by way of, respectively, an input 70 and a second control signal output 68. As used herein, the set of batteries 32, the set of battery cells 34, 36, 38, 40, and the external power source 80 (if optionally present) can collectively be referred to as a set of “power units.” Non-limiting examples of the external power source 80 can include virtually unlimited power, relative to the battery pack 24. For example, the external power source 80 can include wall plug power, generator, an auxiliary power unit, or the like. As used herein, “virtually unlimited” means a sufficient supply of power to be able to recharge the battery bank 24, without regards to extinguishing, emptying, or otherwise exhausting the external power supply 80.

During operation of the battery pack balancing system 30, the set of sensors 46 can sense or measure a respective indicator of the amount of power stored or available in each of the batteries 32 or battery cells 34, 36, 38, 40, such as a voltage value. In the illustration of FIG. 2, the first battery cell 34 is shown having an example voltage value of 3.95 volts, the second battery cell 36 is shown having an example voltage value of 4.1 volts, the third battery cell 38 is shown having an example voltage value of 3.99 volts, and the fourth battery cell 40 is shown having an example voltage value of 4.05 volts. The sensed or measured values can be provided to the set of inputs 70 of the controller module 60.

The controller module 60 or the processor 62 can operably compare the set of sensed or measured values to each other to identify at least one battery 32 or battery cell 34, 36, 38, 40 having the largest amount of power available. In one non-limiting example where the batteries 32 or battery cells 34, 36, 38, 40 are substantially similar (e.g. same composition, same storage capacity, or the like), the largest amount (e.g. or a higher amount) of power available can be identified by the highest sensed or measured voltage, which would be the second battery cell 36 in the illustrated example. The controller module 60 or processor 62 can then operably enable, allow, provide, or the like, the battery 32 or battery cell 34, 36, 38, 40 having the largest amount of power available (e.g. the second battery cell 36 in the example) to supply at least a portion of stored power to recharge at least a subset of the other batteries 32 or battery cells 34, 36, 38, 40. In another non-limiting example where the batteries 32 or battery cells 34, 36, 38, 40 are substantially similar (e.g. same composition, same storage capacity, or the like), the controller module 60 or processor 62 can identify a battery 32 or battery cell 34, 36, 38, 40 having a larger amount (e.g. but not necessarily the largest amount) of power available, relative to at least another battery 32 or battery cell 34, 36, 38, 40 having a smaller amount of power stored or available, can be identified by the sensed measured voltage. The controller module 60 or processor 62 can then operably enable, allow, provide, or the like, the battery 32 or battery cell 34, 36, 38, 40 having the larger amount of power available to supply at least a portion of stored power to recharge at least a subset of the other batteries 32 or battery cells 34, 36, 38, 40 having a smaller amount of power stored or available. For example, the third battery cell 48 could be identified to have a larger amount of power available (3.99 V) relative to the first battery cell 34 (3.95 V), and could thus be controlled to recharge the first battery cell 34.

In one non-limiting example, the controller module 60 or processor 62 can generate a control signal at the second set of outputs 68 to enable the switching elements 44 associated with the second battery cell 36 or second battery cell terminals 48 to close and energize the power rails with energy from the second battery cell 36. In this sense, the power rail 42 is energizing the set of power inputs 42 of the set of power converters 50. The set of power converters 50 can be inoperable, or can be selectably operated such that they do not provide any power converting functions without a control signal enabling the powering converting functions, as previously described. Sequentially, or simultaneously with the aforementioned switching element 44 control, the controller module 60 or processor 62 can generate a control signal at the first set of outputs 66 to enable the power converting functions to operate for a subset of the power converters 50. The subset of the power converters 50 can include any number of the power converters 50 except for the power converter 50 associated with the battery 32 or battery cell 34, 36, 38, 40 having the largest amount of power available.

The operation of the subset of power converters 50 by the controller module 60 can cause the subset of power converters 50 to convert the power received at the respective power input 52 to a different power provided or supplied by the power output 54. The power provided or supplied to the power output 54 can then be provided to the subset of batteries 32 or the subset of battery cells 34, 36, 38, 40 except for the battery 32 or battery cell 34, 36, 38, 40 having the largest amount of power available (e.g. the second battery cell 36 in the current example). In one non-limiting example, the set of power converters 50 can be selected, configured, or operable to convert the power received at the respective power input 52 to a different power supplied to the power output 54, wherein the different power is adapted to recharge the subset of batteries 32 or subset of battery cells 34, 36, 38, 40. For example, if the expected operating voltage of the set of batteries 32 or set of battery cells 34, 36, 38, 40 is 4 volts, non-limiting aspects of the disclosure can be included wherein the set of power converters 50 supply or provide 4 volts at the respective power outputs 52. In another non-limiting aspect of the disclosure, the set of power converters 50 can supply or provide higher voltage values, such as approximately twice the expected operating voltage of the set of batteries 32 or set of battery cells 34, 36, 38, 40 (e.g. 8 volts or higher). The set of power converters 50 can be further configured, selected, or the like to provide a sufficient charging current for recharging the set of batteries 32 or the set of battery cells 34, 36, 38, 40. In one non-limiting example, the charging current supplied by the set of power converters 50 can be 200 milliAmps.

Non-limiting examples of the disclosure can further be included wherein the subset of batteries 32 or battery cells 34, 36, 38, 40 being recharged can further be selected. For instance, aspects of the disclosure can be included wherein only a subset of the batteries 32 or subset of the battery cells 34, 36, 38, 40 having a sensed or measured amount of power available satisfying or below a predetermined power threshold value can be recharged. For instance, in the illustrated example, if a power threshold value of 4 volts was utilized, only the first battery cell 34 and the third battery cell 38 can be simultaneously recharged by the battery pack balancing system 30.

In another non-limiting example, the power threshold value can include a power threshold value range. In this example, non-limiting aspects can be included wherein, for instance, only a subset of batteries 32 or subset of battery cells 34, 36, 38, 40 having a sensed or measured amount of power available satisfying or below a predetermined value (e.g. 4 volts) with a tolerance of five percent will be recharged. In another non-limiting example, the predetermined power threshold value or power threshold value range can be relatively determined with reference to the battery 32 or battery cell 34, 36, 38, 40 having the largest amount of power available (e.g. recharging any batteries 32 or battery cells 34, 36, 38, 40 having a sensed or measured amount of power less than five percent below the largest amount of power available). In another non-limiting example, the predetermined power threshold value or power threshold value range can be based on electrical characteristics of the batteries 32 or the like (e.g. taking into account hysteresis, etc.). In yet another non-limiting example of the battery pack balancing system 30, the controller module 60 can determine that no balancing can take place unless at least one battery 32 or at least one battery cell 34, 36, 38, 40 satisfies a minimum amount of power available. Any number of permutations can be included in the present disclosure.

Non-limiting aspects of the battery pack balancing system 30 can be included wherein, for instance, at least a portion of the power discharged from the battery 32 or battery cell 34, 36, 38, 40 having the largest amount of power available causes that battery 32 or battery cell 34, 36, 38, 40 to reduce the available power until it no longer has the largest amount of power, relative to the set of batteries 32 or battery cells 34, 36, 38, 40. In this case, a new comparison can occur to identify a new battery 32 or battery cell 34, 36, 38, 40 having the then-largest amount of power available to recharge or balance the battery pack 24. The comparisons and the like can occur repeatedly, after triggering events (e.g. a sufficient discharge of the supplying battery 32 or battery cell 34, 36, 38, 40), or after a predetermined period of time.

Non-limiting aspects of the disclosure can be included wherein the battery pack balancing system 30 operates until the entire battery pack 24, set of batteries 32, or set of battery cells 34, 36, 38, 40 have been sufficiently balanced. In this example, sufficiently balanced can include a similar, or substantially similar amount (e.g. within five percent tolerance) of stored power in the respective set of batteries 32 or battery cells 34, 36, 38, 40, or wherein the respective set of batteries 32 or battery cells 34, 36, 38, 40 each satisfies a minimum amount of stored power (e.g. satisfying a minimum power storage threshold value). The battery pack balancing system 30 can operate continuously, sporadically, repeatedly, on a timed schedule, or the like, as desired. Once the battery pack balancing system 30 has sufficiently balanced the set of batteries 32 or battery cells 34, 36, 38, 40, recharging operations can cease, for example, by disabling the set of power converters 50 by way of the first set of outputs 66, opening all switching elements 44 by way of the second set of outputs 68, or the like.

Further non-limiting aspects of the disclosure can be included wherein the external power source 80 can provide at least a portion of the recharging energy. In this regard, the battery pack balancing system 30 can be operable to “see” the external power source 80 as another power unit, similar to the battery bank 24, set of batteries 32, or set of battery cells 34, 36, 38, 40. Effectively, the external power source 80 will have the available power sensed or measured by the respective sensor 46, and can be selectably connected with the power rails 42 by way of the set of switching elements 44. The external power source 80, however, does not need recharging, and thus does not include a respectively associated power converter 50. Aspects of the external power source 80 can be configured, selected, or the like to always have a predetermined amount of power available at the terminals 48, for example, 4.09 volts as shown. Thus, non-limiting examples of the disclosure can be included wherein the external power source 80 can be selected by the controller module (e.g. in response to the sensing and comparing) as the “battery or battery cell” (i.e. the available power unit) having the largest amount of power available, and recharge or balances the stored power in the battery pack balancing system 30. In this example, the external power source 80 can be a secondary or backup power source to ensure the battery bank 24, set of batteries 32, or set of battery cells 34, 36, 38, 40 maintains a minimal charge level relative to the external power source 80. One such application of the aforementioned example can include maintaining an adequate or appropriate battery charge for the battery pack 24 while in longer-term storage or non-use. In one non-limiting example, the use or inclusion of an external inexhaustible low-voltage power source (e.g. the external power source 80) included as part of the battery pack balancing system 30 can result the indefinite maintenance of consistent charge of the battery bank 24, set of batteries 32, or set of battery cells 34, 36, 38, 40.

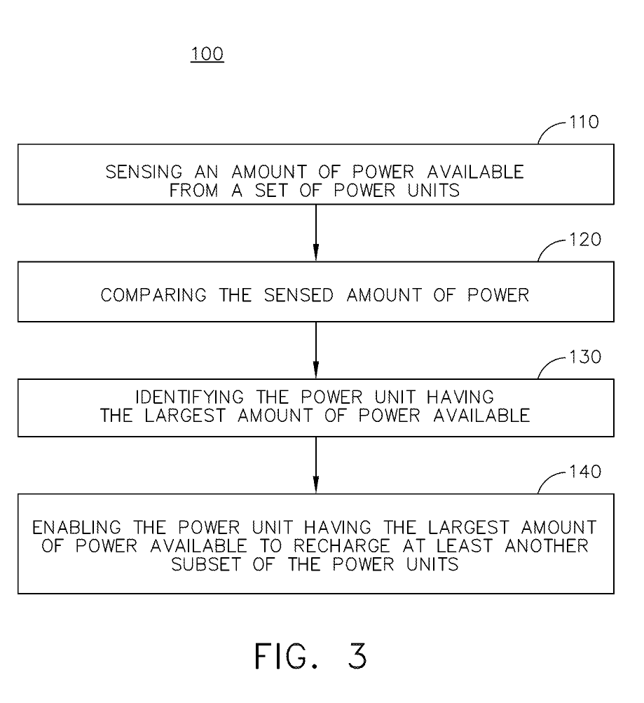

FIG. 3 illustrates a flow diagram demonstrating a method 100 of balancing a battery pack 24. The method 100 begins by sensing, by a set of power sensors 46, a respective amount of power available from a set of power units (e.g. the batteries 32, battery cells 34, 36, 38, 40, optional external power source 80, or a combination thereof), at 110. Next, the method 100 compare, by the controller module 60, the sensed amount of power available from the set of power units 32, 34, 36, 38, 40, 80, at 120. The method 100 can then include identifying, by the controller module 60, the power unit 32, 34, 36, 38, 40, 80 having the largest amount of power available based on the comparison, at 130. The method 100 then enables, by the controller module 60, the power unit 32, 34, 36, 38, 40, 80 having the largest amount of power available to recharge at least another subset of the power units 32, 34, 36, 38, 40, 80, at 140, and as described herein.

The sequence depicted is for illustrative purposes only and is not meant to limit the method 300 in any way as it is understood that the portions of the method can proceed in a different logical order, additional or intervening portions can be included, or described portions of the method can be divided into multiple portions, or described portions of the method can be omitted without detracting from the described method. For example, non-limiting aspects of the method 100 can be included wherein recharging the at least another subset of the power units 32, 34, 36, 38, 40, 80 includes at least partially discharging the power unit 32, 34, 36, 38, 40, 80 having the largest amount of power available. In another non-limiting example, the recharging the at least another subset of the power units 32, 34, 36, 38, 40, 80 can include supplying power from the external power source 80 to the at least another subset of the power units 32, 34, 36, 38, 40. In yet another non-limiting example, the enabling can include selectively connecting the power unit 32, 34, 36, 38, 40, 80 having the largest amount of power available to the power rail 42 selectively connected with the set of power units 32, 34, 36, 38, 40, 80. In yet another non-limiting example, the method 100 can further include operating, by the controller module 60, the set of power converters 50 respectively associated with the subset of the power units 32, 34, 36, 38, 40, 80 and connected with the power rail 42, to convert power supplied by the power rail 42 to a recharging power supplied to the respective subset of the power units 32, 34, 36, 38, 40, 80. Many other possible aspects and configurations in addition to that shown in the above figures are contemplated by the present disclosure.

The aspects disclosed herein provide a battery balancing system for a battery pack. The technical effect is that the above described aspects enable the balancing of energy storage between a set of batteries or battery cells. One advantage that can be realized in the above aspects is that the above described aspects have superior balancing capabilities for balancing multiple batteries charges at once. In typical battery balancing, power is bled or slowly transmitted from higher-charged batteries to lower-charged batteries though resistors. The transmittal through resistors loses some energy supplied as heat. In other typical examples, charge is sequentially transmitted in a sequential process from battery to battery. The current disclosure allows or provides for multi-battery-charging capabilities in a single balancing activity.

Another advantage of the above described aspects can include that the power converters can operate as DC to DC power converters, which can operate with efficiencies greater than 85%, reducing wasted energy not utilized to charge other batteries or cells. Reducing wasted energy improves the overall efficiency of the battery pack balancing system. Yet another advantage of the above described aspects is that a controller module can be included for providing digital or logical arbitration or control over which cells are being recharged or discharged, providing for any number of control schemes to be implemented.

Yet another advantage of the above described aspects is that the aforementioned battery pack balancing system can include an external power source, providing a supply of recharging power to the cells, without modification of the overall operations of the battery pack. In this sense, the battery pack balancing system “sees” the external power source as another batter that never needs recharging, but can supply nearly limitless power to the other batteries or battery cells, as needed. In this example, the battery pack balancing system can reliably ensure battery charging, balancing, or the like, over an extended period of time or battery pack non-use, such as long-term storage, without loss or compromising battery-pack reliability due to self-discharge.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A battery pack balancing system comprising:
a set of battery cells having a respective set of terminals selectably connected with a power rail;
a set of power converters connected with the power rail and the set of terminals;
a set of sensors adapted to sense the amount of power available at the respective terminals of the set of battery cells; and
a controller module adapted to receive the sensed power available at the respective terminals of the set of battery cells from the set of sensors, identify the battery cell having a larger amount of power available at the terminals, relative to at least one other battery cell, selectably connect the battery cell having the larger amount of power available at the terminals with the power rail, and controllably operate at least a subset of the power converters to recharge at least a corresponding subset of the battery cells having a smaller amount of power, relative to the battery cell having the larger amount, by way of discharging the battery cell having the larger amount of power available at the terminals.

2. The battery pack balancing system of claim 1 wherein the set of power converters are adapted to convert power received by the power rail to at least twice a nominal battery cell voltage.

3. The battery pack balancing system of claim 1 wherein controller module controllably operates at least a subset of the power converters to recharge the subset of battery cells having an amount of power available at the terminals less than a power storage threshold value.

4. The battery pack balancing system of claim 1 wherein the set of terminals are selectably connected with the power rail by way of a respective set of electrical switches.

5. The battery pack balancing system of claim 3 wherein the set of sensors are voltage sensors connected with the respective set of terminals.

6. The battery pack balancing system of claim 1 wherein the controller module adapted to, identify the battery cell having the largest amount of power available at the terminals, selectably connect the battery cell having the largest amount of power available at the terminals with the power rail, and controllably operate at least a subset of the power converters to recharge at least a corresponding subset of the battery cells by way of discharging the battery cell having the largest amount of power available at the terminals.

7. The battery pack balancing system of claim 1 further comprising a power unit having a set of terminals selectably connected with the power rail, and a sensor adapted to sense the amount of power available at the power unit terminals.

8. The battery pack balancing system of claim 7 wherein the power unit includes a power supply adapted to supply power greater than a power storage threshold value.

9. The battery pack balancing system of claim 1 wherein the controller module is further adapted to cease the recharging of the subset of battery cells in response to satisfying a comparison of the sensed power available at the respective terminals of the subset of battery cells with a power storage threshold value.

10. A method of balancing a battery pack, comprising
sensing, by a set of power sensors, a respective amount of power available from a set of power units;
comparing, by a controller module, the sensed amount of power available from the set of power units;
identifying, by the controller module, the power unit having the largest amount of power available based on the comparison; and
enabling, by the controller module, the power unit having the largest amount of power available to recharge at least another subset of the power units.

11. The method of claim 10 wherein the set of power units comprises a set of battery cells.

12. The method of claim 10 wherein recharging the at least another subset of the power units includes at least partially discharging the power unit having the largest amount of power available.

13. The method of claim 10 wherein the set of power units comprises an external power source.

14. The method of claim 13 wherein the external power source has a threshold amount of power available.

15. The method of claim 13 wherein recharging the at least another subset of the power units includes supplying power from the external power source to the at least another subset of the power units.

16. The method of claim 10 wherein enabling includes selectively connecting the power unit having the largest amount of power available to a power rail selectively connected with the set of power units.

17. The method of claim 16 further comprising operating, by the controller module, a set of power converters respectively associated with the subset of the power units and connected with the power rail, to convert power supplied by the power rail to a recharging power supplied to the respective subset of the power units.

18. A battery pack balancing system comprising:
a set of power units including a set of battery cells and at least one external power source, the set of power units having a respective set of terminals selectably connected with a circuit;
a set of sensors adapted to sense the amount of power available at the respective terminals of the set of power units; and
a controller module adapted to receive the sensed power available at the respective terminals of the set of power units from the set of sensors, identify the power unit having the largest amount of power available at the terminals, selectably supply power from the power unit having the largest amount of power available at the terminals to the circuit, and controllably recharge at least a corresponding subset of the battery cells by way of the circuit.

19. The battery pack balancing system of claim 18 wherein the circuit further comprises a set of power converters associated the respective set of battery cells, the set of power converters adapted to convert power received from the circuit to a recharging power supplied to the subset of the power units.

20. The battery pack balancing system of claim 18 wherein the controller module is further adapted to cease the recharging of the subset of battery cells in response to satisfying a comparison of the sensed power available at the respective terminals of the subset of battery cells with a power storage threshold value.
